(19) United States
(12) Patent Application Publication
(10) Pub. No.: US 2005/0153740 A1
(43) Pub. Date: Jul. 14, 2005

(54) Linked storage for enhanced phone book entries in mobile communications devices and methods

(76) Inventors: Charles P. Binzel, Bristol, WI (US); Carl A. Grube, Vernon Hills, IL (US); Marcia J. Otting, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 10/755,901

(22) Filed: Jan. 13, 2004

(51) Int. Cl. H04B 1/38

(52) U.S. Cl. 455/558

(57) ABSTRACT

A method in a mobile electronics device, for example, a wireless cellular telephone handset, including coupling (210) a removable memory device to the mobile electronics device, generating key information (230) based on the record information and based on identity information unique to the mobile electronics device, determining (240) whether the record information of the removable memory device is associated with information stored on the mobile electronics device using the key information generated, creating (250) a temporary link between information stored on mobile electronics device and associated record information stored on the removable memory device coupled to the mobile electronics device.

### FIELD OF THE DISCLOSURE

The present disclosure relates generally to wireless communications devices, and more particularly to relating information, for example, phone book entries, stored on removable modules, e.g., Subscriber Identity Modules (SIMs), User Identification Modules (UIMs), Multi-Media cards (MMC), smart cards, etc., to other information stored on the communications device, and methods.

### BACKGROUND OF THE DISCLOSURE

In many wireless communications devices, repertory information directories, for example, phone books, contain or link to much more information, for example, voice recognition tags, multimedia files, etc., than may be stored on removable memory devices, for example, on existing Subscriber Identification Module (SIM) cards and User Identification Module (UIM) cards, etc., some of which have limited memory.

United States Patent Application Publication No. U.S. 2003/0083873 A1 to Ross et al. entitled “Method of Associated Voice Recognition Tags In An Electronic Device With Records In A Removable Media For Use With the Electronic Device” discloses associating voice recognitions tags stored in non-volatile memory of a cellular radiotelephone device with data records stored on a removable Subscriber Identity Module (SIM) of the radiotelephone using a digital key. In Ross et al., the digital key is based on a corresponding data record, and preferably on the entire record, for example, by producing a cryptographic hash of the data record.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary mobile communications device.

FIG. 2 is an exemplary process description diagram.

FIG. 3 is an exemplary schematic diagram illustrating the linking of information on a removable memory card with other information.

FIG. 4 is an exemplary process for associating record information with supplemental information using key information.

### DETAILED DESCRIPTION

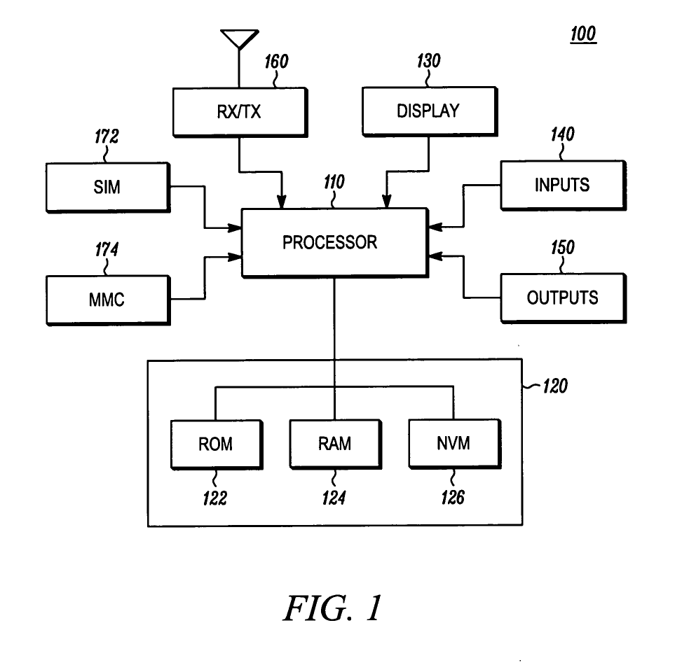

FIG. 1 is an exemplary electronics device 100 comprising generally a processor 110, for example, a CPU and/or a digital signal processor (DSP), coupled to memory 120, which may include, for example, read-only memory (ROM) 122 and/or random-access memory (RAM) 124 and/or non/volatile memory (N/VM) 126, among other memory or information storage devices. The processor may also include internal cache memory or have access to external cache, known but not illustrated. The exemplary electronics device also includes a display 130, and inputs 140 and outputs 150, more particular examples of which are discussed below.

The exemplary electronics device 100 also includes a wireless transceiver 160. In one embodiment, the electronics device is a mobile communications device compliant with a wireless communications protocol, for example, Global System for Mobile Communications (GSM), 3^{rd} Generation (3G) Universal Mobile Telecommunications System (UMTS) W-CDMA, CDMA, or some other open or proprietary communications protocol, including satellite-based communications protocols. In the exemplary cellular communications device embodiment, the inputs include a microphone, hard and/or soft input keys, touch screens and pads, etc., among other inputs suitable for use on such devices. Exemplary outputs include loudspeakers, audio output jacks, tactile output devices, etc. among other suitable outputs.

Alternatively, the electronics device may be a laptop or notebook computer or some other hand held or portable device enabled with a radio transceiver, for example, one of the exemplary cellular protocols discussed above, IEEE 802.11, Bluetooth, infrared, etc., or combinations thereof. In these exemplary embodiments, the inputs may include a microphone, keyboards, touch pads and screens, pointing devices, disk drives, etc. among other inputs suitable for use on such devices. Exemplary outputs for this embodiment include loudspeakers, audio output jacks, etc., among other suitable outputs.

In other applications, the electronics device includes only a receiver wherein the device is embodied, for example, as a pager for receiving radio frequency paging information, or a satellite positioning system (SPS) receiver for receiving Galileo, NAVSTAR Global Positioning System (GPS), GLONASS or some other satellite-based navigation signals. The electronics device may also take the form of a mobile personal organizer or personal digital assistance (PDA) that does or does not include transceiver(s). The functionality of a pager, positioning device, personal organizer, etc., and combinations thereof may be integrated into any one of the exemplary electronics devices discussed above.

In some embodiments, the electronics device includes one or more removable memory or storage devices. In FIG. 1, the exemplary mobile communications device includes a smart card, for example, in the form of a GSM subscriber identification module (SIM) 172. The exemplary SIM card includes unique subscriber identification information, phone book entries, record entries, etc., among other information. In other embodiments, the smart card is a User Services Identity Module or Universal Subscription Identity Module (USIM) associated with some UMTS communications devices, or a smart card used in some other wireless communications protocol. More generally, the smart card is some other removable memory module with some type identification information, which is not necessarily a wireless subscriber identity, for example, a user defined password.

In FIG. 1, the exemplary mobile communications device also includes a second removable memory device 174, for example, a multi-media card (MMC) for storing multimedia information, for example, video, audio, photographic information, etc. In some embodiments, the information on the second removable memory device is associated with information on the first removable memory device 172 when the card is coupled to the electronics device as discussed more fully below.

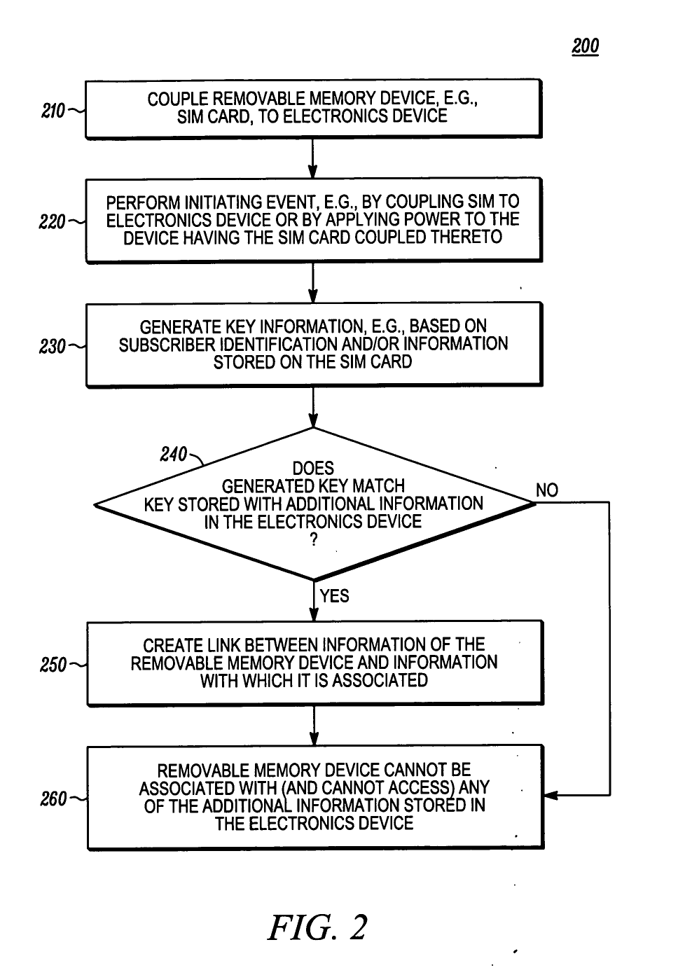

In the exemplary process description diagram 200 of FIG. 2, at block 210, a removable memory device, for example, a SIM card having identification and record information, is coupled to an electronic device. At block 220, an initiating event is performed, for example, upon coupling the SIM card to the electronic device, or upon applying power to the electronic device having the smart card coupled thereto. In other embodiments, the initiating event may result from some other action.

In FIG. 2, at block 230, in response to the initiating event, key information is generated. In one embodiment, the key information is for determining whether any prior associations have been made between information of or on the removable memory device, for example, SIM card 172 in FIG. 1, and supplemental information stored on the communications device, for example, information stored in NVM 126 or on MMC 174 in FIG. 1. In one embodiment, the key information is generated based at least partly on identity information of the first removable memory device, as discussed further below.

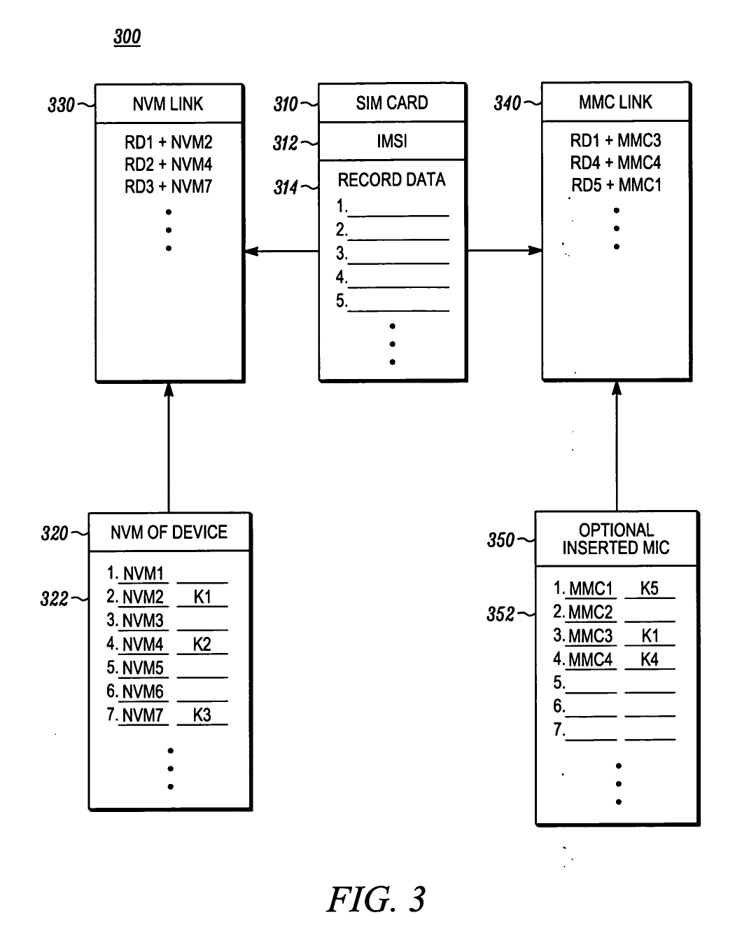

In the exemplary wireless communications smart card application, for example, the key information is generated from a subscriber identification portion of an International Mobile Subscriber Identity (IMSI) stored on the smart card. FIG. 3 illustrates an exemplary SIM card 310 including IMSI information 312, which includes subscriber identity information pursuant to one or more wireless communications protocols. In another embodiment, the key information is generated from other types of information on the removable memory device. In some embodiments, the key information is based on both the identity information and on other information of the removable memory card. FIG. 3 also illustrates record information 314 stored on the SIM card 310. The record information 314 is typically stored at a particular address in memory. In one exemplary application, a key is generated for each record, for example, phone book entries, stored on the first removable memory device using corresponding record information and using the identification information. In one particular embodiment, the phone book entries or other record information stored on the SIM card is one-way encrypted using IMSI information to create a key upon the performance of an initiating event, thereby creating and associating a unique key with each record of the removable memory device. In other embodiments, the key information is based on information other than identification information and/or record information.

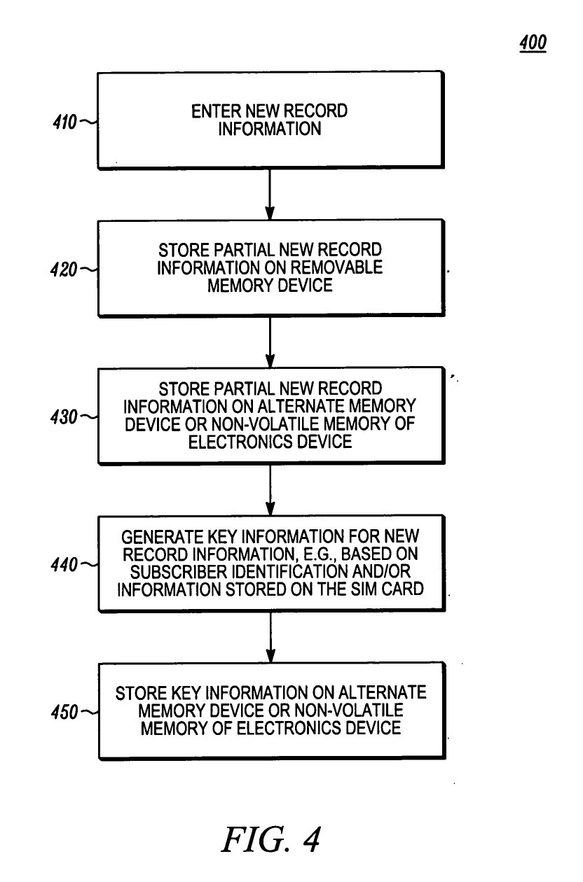

In one embodiment, information of the removable memory module is associated with voice tags or other information stored in NVM or in a second removable memory card using the tag information. In the exemplary process diagram 400 of FIG. 4, at block 410 record information, for example, a new phone book entry, is entered, and at block 420 the record information is stored on the first removable memory device, e.g., on the SIM card. At block 430, supplemental record information is stored in some location other than the first removable memory device, for example, in NVM 126 or on MMC 174 in FIG. 1. At block 440, a key is generated for the new record information entered at block 410, for example, as discussed above in connection with block 230 of FIG. 2. Alternatively, the key may be generated for a previously entered record identified by the user. At block 450, the key generated is stored in association with the selected supplemental information stored in the location other than the first removable memory device. The processes of blocks 440 and 450 may also occur upon associating previously generated record information, e.g., a phonebook entry, of the first removable memory device with pre-existing supplemental information, e.g., a voice or picture tag, stored elsewhere. In one embodiment, key information for each record of the smart card is initially associated with corresponding voice tags or notes, photos, etc. or other supplemental information stored in another location using the key information. The corresponding key information is also stored in association with the supplemental information for later linking the information of the first removable memory device with the supplemental information stored at the other location as discussed further below.

In FIG. 2, at block 210, the next time the first removable memory device is coupled to the electronics device, or upon the next occurrence of the initiating event at block 220, as discussed above, the key information is regenerated at block 230. At block 240, a determination is made as to whether any information of the removable memory device has been previously associated with supplemental information stored on the electronics device. In one embodiment, the determination at block 240 of FIG. 2 is made by comparing the key information generated at block 230 with key information generated and stored previously in NVM or on the second removable memory device in association with the corresponding supplemental information, e.g., in association with voice tags, as discussed above.

FIG. 3 illustrates exemplary an NVM medium 320 having supplemental record information (NVM#) and associated key information (K#) 322 stored thereon. Alternatively, the medium 320 of FIG. 3 may also be a second removable memory card or some other storage device, for example, MMC 172 in FIG. 1, or a disk drive, etc. The information 322 is typically stored at corresponding addresses in memory. If there is a match between the key information generated in response to the initiating event and key information associated with the supplemental information, e.g., voice tags, stored in NVM or on the other memory device, then the record information in the removable memory device is linked with supplemental information. In one embodiment, an associating code, for example, a SIM Toolkit application, is stored on the smart card with the record information and with any identification information. In one embodiment, the associating code generates the key information, determines whether there is a match, and creates links as discussed below.

In FIG. 2, at block 250, a link is created between the information of the removable memory device and any associated supplemental information stored on the electronics device. In one embodiment, the link is a table stored in volatile or non-volatile memory of the electronics device, for example, in RAM 124 in FIG. 1. FIG. 3 illustrates diagrammatically the creation of exemplary NVM link 330 that links record information, i.e., RD1, RD2, RD3 . . . , from the SIM card 310 to associated record information, i.e., M1, M2, M3 . . . , from the NVM device 320 in FIG. 3. In FIG. 3, in NVM device 320, keys K1, K2 and K3 generated in association with SIM records RD1, RD2 and RD3 are associated with supplemental NVM information records 2, 4 and 7, respectively. Thus NVM link 330 includes associations between RD1+NVM2, RD2+NVM4 and RD3+NVM7. Similar associations are made between records in the SIM card 310 and the MMC device 350 in MMC link 340.

In one exemplary embodiment, the exemplary NVM link 330 and MMC link 340 includes one or more pointers to the associated information on the respective mediums. In some protocols, the interface, for example, a serial interface, between a removable memory device and the electronics device may impose limitations data transfer rates. Storing the record information together in a memory device, for example, RAM or cache, increases its accessibility, i.e., reduces processing time associated with using the information. Thus in some embodiments, the information, for example, record information 314 on the SIM card 310 in FIG. 3, is stored, e.g., in cache, on the electronics device, for example, upon coupling the SIM card to the device or upon applying power to the device with the SIM card connected thereto. Thus in the exemplary voice tag/phonebook entry application discussed above, the link would locate the phone book entry in cache instead of on the smart card. In some embodiments where the smart card data is cached, the cached data is eliminated or deleted from memory, e.g., cache, upon removing power from the electronics device or upon de-coupling the SIM card from the device. In other embodiments, the link is eliminated upon the occurrence of some other specified event. In other embodiments, the information is read directly from the SIM card without caching.

In another embodiment, the information on the SIM card, e.g., a phonebook record, is combined with the associated information, e.g., voice tag, stored on the NVM or other removable memory device, and the combination is stored in memory, for example, in RAM or cache, on the electronics device. The supplemental data may be combined with the record information from the SIM when caching is performed, such that the storage structure is substantially the same as that of internal phonebook entries. In this exemplary embodiment, the link could be considered combination of the record or other information from the SIM and the associated voice tag or other supplemental information. In some embodiments, the combined data stored on the electronics device is deleted or eliminated from memory upon removing power from the device or upon de-coupling the SIM card from the device. Alternatively, the combined information may remain on he device, but accessibility to the information could be limited to when the corresponding SIM card is coupled to the electronics device.

In one exemplary application, when a voice tag is activated orally, upon speaking the voice tag, the phone number or other record information on the SIM card associated with the activated voice tag is located. In one scenario, the phone number would be dialed upon speaking the voice tag. In another related application, the voice tag could be enunciated by scrolling through the phone book, and the corresponding phone book entry stored on the SIM could then be located using the link. In this latter scenario, the phone number could be dialed upon depressing a talk input.

In some applications, an electronics device, for example, a cellular telephone, is shared among multiple users that store data, e.g., voice tags, photos, links, etc., on the shared electronics device that is associated with information on corresponding removable memory devices, e.g., SIM cards, of the various users. According to one aspect of the disclosure, users of the shared electronics device have limited access to at least some of the information stored on the mobile electronics device, for example, to voice or picture tag information associated with their particular SIM card. In FIG. 2, at block 260, information of the first removable memory device, e.g., record information on a SIM card, cannot be associated with and the user cannot access certain information stored on the electronics device, e.g., in NVM 126 or on the MMC 174 in FIG. 1 not previously associated with information on the SIM card.

In one embodiment, for example, when the electronics is powered-on or a SIM is inserted into the device, key information is generated from the phone number and IMSI as the SIM repertory memory is being cached. The tag information is used to determine if there is an association between the SIM repertory information and any other supplemental information as discussed above. If an association or match is found, then a link is created thereby providing access to the supplemental information linked to the repertory information. The link could be a pointer to the locations where the record and supplemental information are stored, or it could be the location of the combine record and supplemental information. In some embodiments, access is denied to the supplemental information that is not linked to the repertory information on the SIM card. Thus, in at least some embodiments, the tags generated and/or stored by other users are not accessible to a present user, enabling a single electronic device to be shared by multiple users with corresponding SIM cards with information associated to a private set of supplemental information stored on the shared device. This linkage method provides for sufficient privacy of associated phone book entry data while providing the user with storage features that are otherwise unavailable to SIM phone book entries.

In some embodiments, the link and/or any information stored, for example, voice tags cached, on the electronics device, is eliminated upon removing the removable memory, SIM card from which the voice tags were obtained, or upon removing power applied to the electronics device. Thus upon replacing the first removable memory device coupled to the mobile electronics device with a second removable memory device, for example, the SIM card of a another user, a second link between generally different information stored on the mobile electronics device and associated record information stored on the second removable memory device is established.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a mobile electronics device, the method comprising:
performing an initiating event;
generating key information based on information of a removable memory device coupled to the mobile electronics device and based on unique mobile electronics device identity information in response to the initiating event.

2. The method of claim 1, determining whether any of the information of the removable memory device is associated with information stored on the mobile electronics device using the key information generated in response to the initiating event.

3. The method of claim 2, determining whether any of the information of the removable memory device is associated with the information stored on the mobile electronics device includes comparing the key information generated to key information previously stored on the mobile electronics device in association with the information stored on the mobile electronics device.

4. The method of claim 2, creating a link between the information of the removable memory device and any associated information stored on the mobile electronics device.

5. The method of claim 4, creating the link includes combining the information of the removable memory device and any associated information stored on the mobile electronics device.

6. The method of claim 2, combining the information stored on the mobile electronics device with any associated information of the removable memory device in cache memory of the mobile electronics device.

7. The method of claim 1,
the mobile electronics device is a wireless communications device, the unique mobile electronics device identity information includes international subscriber identity information stored on the removable memory device,
generating the key information based on at least a portion of the international mobile subscriber identity information.

8. The method of claim 1, generating the key information upon at least one of applying power to the mobile electronics device with the removable memory device already coupled to the mobile electronics device and coupling the removable memory device into the mobile electronics device.

9. The method of claim 2, providing access to at least some information stored on the mobile electronics device only if the information stored on the mobile electronics device is associated with the record information of the removable memory device.

10. A method in a mobile electronics device, the method comprising:
determining whether any record information stored on a removable memory device coupled to the mobile electronics device is associated with record related information stored on the mobile electronics device using the key information;
creating a link between the record information and any associated record related information when the removable memory device is coupled to the mobile electronics device;
providing access to the record related information stored on the mobile electronics device that is linked to the record related information stored on the removable memory device coupled to the mobile electronics device;
denying access to at least some record related information stored on the mobile electronics device that is not linked to the record information of the removable memory device coupled to the mobile electronics device.

11. The method of claim 10, generating the key information based on record information of the removable memory device coupled to the mobile electronics device and based on unique mobile electronics device identity information in response to performing an initiating event.

12. The method of 11, performing the initiating event upon at least one of applying power to the mobile electronics device when the removable memory device is coupled thereto and coupling the removable memory device to the mobile electronics device.

13. The method of claim 10, eliminating the link between the record information and any associated record related information upon at least one of de-coupling the removable memory device from the mobile electronics device and removing power applied to the mobile electronics device.

14. The method of claim 10, creating the link includes combining and storing the record information and any associated record related information in memory of the mobile electronics device.

15. A method in a mobile electronics device, the method comprising:
coupling a removable memory device to the mobile electronics device;
generating key information based on the record information and based on identity information unique to the mobile electronics device;
determining whether the record information of the removable memory device is associated with information stored on the mobile electronics device using the key information generated;
creating a temporary link between information stored on mobile electronics device and associated record information stored on the removable memory device coupled to the mobile electronics device.

16. The method of claim 15, preventing access to at least some information of the mobile wireless communications device that is not associated with record information of the removable memory device coupled to the mobile electronics device.

17. The method of claim 15, eliminating the temporary link upon at least one of de-coupling the removable memory device from the mobile electronics device and removing power applied to the mobile electronics device having the removable memory device coupled thereto.

18. The method of claim 15, generating the key information upon at least one of coupling the removable memory device to the mobile electronics device and applying power to the mobile electronics device having the removable memory device coupled thereto;

19. A method in a mobile electronics device, the method comprising:
coupling a first removable memory device to the mobile electronics device;
creating a first link between information stored on the mobile electronics device and associated record information stored on the first removable memory device coupled to the mobile electronics device;
replacing the first removable memory device coupled to the mobile electronics device with a second removable memory device coupled to the mobile electronics device;
creating a second link between information stored on the mobile electronics device and associated record information stored on the second removable memory device coupled to the mobile electronics device.

20. The method of claim 19, eliminating the first link upon replacing the first removable memory device with the second removable memory device.

21. The method of claim 19,
generating first key information based on the first record information and based on identity information unique to the mobile electronics device upon at least one of coupling the first removable memory device to the mobile electronics device and applying power to the mobile electronics device having the removable memory device coupled thereto;
determining whether the first record information of the first removable memory device is associated with information stored on the mobile electronics device using the first key information generated.
